(19) United States
(12) Patent Application Publication
(10) Pub. No.: US 2006/0273729 A1
(43) Pub. Date: Dec. 7, 2006

(54) Metal halide high-pressure discharge lamp

(75) Inventor: Hans-Werner Golling, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/447,169

(22) Filed: Jun. 6, 2006

(30) Foreign Application Priority Data
Jun. 7, 2005 (DE) 10 2005 026 207.4

(51) Int. Cl. H01J 17/20; H01J 61/12; H01J 61/20

(52) U.S. Cl. 313/640; 313/637

(57) ABSTRACT

In the metal halide high-pressure discharge lamp for stage, film and television lighting systems and for projection technology and effect lighting, the discharge vessel contains indium and/or tin and/or thallium as metals for the metal halides. Optimum results for dimmability, arc instability and color rendering are achieved if the fill additionally includes 0.12 to 3.8 μmol of vanadium and if appropriate 0.05 to 1.0 μmol of zirconium per ml of vessel volume. These metals achieve improved color rendering of greater than 85 and improved red rendering.

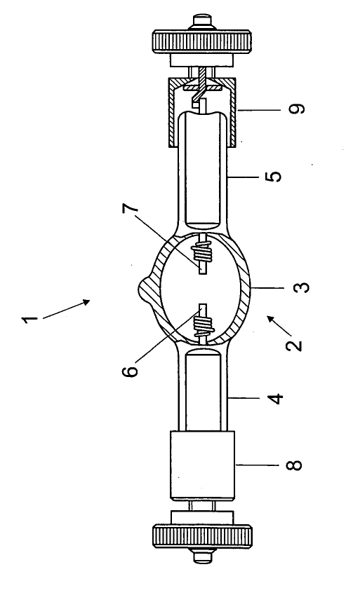

### TECHNICAL FIELD

The invention relates to a metal halide high-pressure discharge lamp having a discharge vessel made from light-transmitting material which is stable at high temperatures, two electrodes which are able to withstand high temperatures and a fill comprising mercury, at least one noble gas, if appropriate cesium and metal halides of indium and/or tin and/or thallium, but no rare earths.

### BACKGROUND ART

Metal halide high-pressure discharge lamps of this type are used in particular in lighting systems for stage, film and television, where light with color temperatures of between 5000 and 9000 K and very good color rendering in all color temperature ranges is required. More recently, these lamps have also been used in projection technology, architecture illumination and effect lighting.

U.S. Pat. No. 6,380,675 has disclosed mercury vapor high-pressure discharge lamps with halide additions of indium and/or tin and/or thallium. These lamps emit radiation with a color temperature of between 5000 and 9000 K and a general color rendering index Ra of greater than 70, with the color rendering index R₉ for the red spectral region reaching values of up to 50.

However, one drawback is that these lamps are prone to arc instability if the indium, tin and/or thallium content is too high. Moreover, when dimming or boosting the lamps, the temperature change in the burner has a considerable influence on the vapor pressure of the metal halides, leading to a considerable change in the color temperature and color rendering.

### DISCLOSURE OF THE INVENTION

It is an object of the invention to provide a metal halide high-pressure discharge lamp having the abovementioned features with regard to color temperature and color rendering index, in which the abovementioned drawbacks are as far as possible eliminated.

This object is achieved in metal halide high-pressure discharge lamps having a discharge vessel made from light-transmitting material which is stable at high temperatures, two electrodes which are able to withstand high temperatures and a fill comprising mercury, at least one noble gas, if appropriate cesium and metal halides of indium and/or tin and/or thallium, by the further addition of vanadium.

Vanadium halide has a high vapor pressure even at low temperatures. Therefore, at the standard burner temperatures of these lamps, the vanadium fill which is added has already completely evaporated. The result of this is in particular that very high Ra values are achieved in the saturated red (i.e. with regard to the R₉ value).

The metal halide high-pressure discharge lamp advantageously contains vanadium in a quantity of in each case from 0.12 to 3.8, preferably 0.35 to 3.0 μmol per ml of vessel volume.

If the vanadium is also combined with zirconium, it is possible to raise the color temperature in the blue wavelength region, which leads to a further improvement in Ra and R₉ values. In addition, the light yield is increased. It is therefore possible to adapt the color temperature, color rendering and light yield requirements for the various application areas within wide limits by the addition of vanadium and if appropriate zirconium.

The absence of rare earth elements in particular allows a 300 W lamp to be operated with a low wall loading without blackening and devitrification occurring over the service life of the lamp. As a result, a service life of over 300 hours is achieved. The abovementioned drawbacks only occur significantly later than in the case of lamp fills with rare earth fractions. Iodine and bromine are present only in a stoichiometric ratio. The lamp cycle therefore operates without an excess of halogen.

Moreover, the combination of vanadium and zirconium greatly reduces the change in color temperature during dimming or boosting, since both halide compounds are complete evaporated and therefore it is impossible for any change in vapor pressure (and therefore change in particle density) to occur in the plasma of the burner during dimming or boosting. Vanadium and zirconium presumably form cluster-like molecules similarly to hafnium.

It is advantageous for the discharge vessel to additionally contain zirconium in a quantity of in each case from 0.05 to 1.0, preferably 0.15 to 0.8 μmol per ml of vessel volume.

The quantity of indium in the metal halide composition of the discharge vessel should advantageously be between 0.2 and 2.0 μmol, that of tin between 0.5 and 5.0 and the quantity of thallium between 0.05 and 0.5 μmol per ml of vessel volume. The discharge vessel of the metal halide high-pressure discharge lamp advantageously contains iodine and bromine in a molar ratio of between 0.1 and 4 as halogens for the halide compounds. The quantity of cesium should be at least 0.5 μmol per ml of vessel volume.

Other additions, such as for example niobium, which have been tested, did not bring about any improvement in the desired sense.

### BRIEF DESCRIPTION OF THE DRAWING(S)

The invention is explained in more detail on the basis of the following exemplary embodiments.

### BEST MODE FOR CARRYING OUT THE INVENTION

The figure shows a partially sectional side view of a metal halide high-pressure discharge lamp 1 according to the invention which is capped on two sides and has a power consumption of 300 W.

The discharge vessel 2 made from quartz glass has an elliptical lamp bulb 3 and has a lamp neck 4, 5 at each of two diametrically opposite locations, into each of which lamp necks a pin-like tungsten electrode 6, 7 with an attached filament is fused by means of a molybdenum sealing foil, which is not visible here. Those ends of the sealing foils which are remote from the lamp bulb are connected to the caps 8, 9 via supply conductors.

The table below gives a compilation of two different fills for the discharge vessel 2 and the lighting engineering data achieved with the respective fill.

TABLE 1

| | Fill 1 | | Fill 2 | |
|---|---|---|---|---|
| InI₂ | 0.63 | mg | 0.63 | mg |
| SnBr₂ | 0.67 | mg | 0.67 | mg |
| VI₂ | 0.38 | mg | 0.18 | mg |
| TlI₂ | 0.12 | mg | 0.12 | mg |
| Hg | 34 | mg | 34 | mg |
| Ar/Kr | 130 | hPa | 130 | hPa |
| Power consumption | 300 | W | 300 | W |
| Discharge vessel volume | 1.40 | ml | 1.40 | ml |
| Electrode-to-electrode distance | 5.5 | mm | 5.5 | mm |
| Operating voltage | 80 | V | 80 | V |
| Lamp current | 4.3 | A | 4.3 | A |
| Color temperature | 5900 | K | 6500 | K |
| Light yield | 66 | Im/W | 68 | Im/W |
| Color rendering index Ra | 93 | | 86 | |
| Red rendering index R₉ | 63 | | 22 | |
| Service life | 3000 | h | 3000 | h |

What is claimed:

1. A metal halide high-pressure discharge lamp having a discharge vessel made from light-transmitting material which is stable at high temperatures, two electrodes which are able to withstand high temperatures and a fill comprising mercury, at least one noble gas, if appropriate cesium and metal halides of indium and/or tin and/or thallium, but no additions of rare earths, wherein the lamp , to generate light with a color temperature of between 5000 and 9000 K, a general color rendering index Ra of greater than 85 and a color rendering index R₉ for the red spectral region of greater than 20, additionally contains vanadium as metals for the metal halides.

2. The metal halide high-pressure discharge lamp as claimed in claim 1, wherein the discharge vessel contains vanadium in a quantity of from 0.12 to 3.8 μmol per ml of vessel volume.

3. The metal halide high-pressure discharge lamp as claimed in claim 1, wherein the discharge vessel contains vanadium in a quantity of from 0.35 to 3.0 μmol per ml of vessel volume.

4. The metal halide high-pressure discharge lamp as claimed in claim 1, wherein the discharge vessel additionally contains zirconium in a quantity of from 0.05 to 1.0 μmol per ml of vessel volume.

5. The metal halide high-pressure discharge lamp as claimed in claim 1, wherein the discharge vessel additionally contains zirconium in a quantity of in each case from 0.15 to 0.8 μmol per ml of vessel volume.

6. The metal halide high-pressure discharge lamp as claimed in claim 1, wherein the discharge vessel contains indium in a quantity of from 0.2 to 2.0 μmol per ml of vessel volume.

7. The metal halide high-pressure discharge lamp as claimed in claim 1, wherein the discharge vessel contains tin in a quantity of from 0.5 to 5.0 μmol per ml of vessel volume.

8. The metal halide high-pressure discharge lamp as claimed in claim 1, wherein the discharge vessel contains thallium in a quantity of from 0.05 to 0.5 μmol per ml of vessel volume.

9. The metal halide high-pressure discharge lamp as claimed in claim 1, wherein the discharge vessel contains iodine and bromine in a molar ratio of between 0.1 and 4 as halogens for the halide compounds.

10. The metal halide high-pressure discharge lamp as claimed in claim 1, wherein the discharge vessel contains cesium in a quantity of at least 0.5 μmol per ml of vessel volume.
